(19) United States
(12) Patent Application Publication
(10) Pub. No.: US 2024/0351581 A1
(43) Pub. Date: Oct. 24, 2024

(54) OPERATION ASSISTANCE SYSTEM AND OPERATION ASSISTANCE METHOD

(71) Applicant: HONDA MOTOR CO., LTD., Tokyo (JP)

(72) Inventor: Masamitsu Shiono, Wako-shi (JP)

(21) Appl. No.: 18/636,389

(22) Filed: Apr. 16, 2024

(30) Foreign Application Priority Data
Apr. 19, 2023 (JP) 2023-068672

(51) Int. Cl. B60W 30/09; B60Q 9/00; B60W 10/18; B60W 10/20; G06V 20/59

(52) U.S. Cl. CPC B60W 30/09; B60Q 9/008; B60W 10/18; B60W 10/20; G06V 20/597; B60W 2420/403; B60W 2540/225; B60W 2554/80

(57) ABSTRACT

An operation assistance system includes: a driver image acquisition section that acquires an image of a driver in the movable body; a line-of-sight direction recognition section that recognizes the direction of the line of sight of the driver on the basis of the image; a length-between-pupils recognition section that recognizes the length between right and left pupils of the driver on the basis of the image; a viewing-object determination section that determines whether or not the driver views an object on the basis of the direction of the line of sight of the driver and the length between pupils of the driver; and a drive assistance control section that executes drive assistance processing for assisting driving of the movable body in a case where the viewing-object determination section determines that the driver does not view the object.

### INCORPORATION BY REFERENCE

The present application claims priority under 35 U.S.C. § 119 to Japanese Patent Application No. 2023-068672 filed on Apr. 19, 2023. The content of the application is incorporated herein by reference in its entirety.

### BACKGROUND OF THE INVENTION

### Field of the Invention

The present invention relates to an operation assistance system and an operation assistance method.

### Description of the Related Art

In recent years, more and more attempts have been actively made to provide access to a sustainable transportation system which is considerate of vulnerable road users among traffic participants. To achieve this, research and development focused on further improvement in traffic safety and convenience has been made through research and development relating to preventive safety technology.

For example, Japanese Patent Laid-Open No. 2019-174693 discloses a configuration of a head-up display (HUD) mounted on a vehicle, in which a viewing distance to a virtual image projected by the HUD from a user who views the virtual image is changeable and the brightness of the virtual image is adjustable according to the viewing distance.

In terms of preventive safety technology, it is requested to execute operation assistance processing to support driving when it is estimated that the driver does not recognize an object that can come into contact with the vehicle. However, it is sometimes difficult to distinguish a situation where the driver views an object outside the vehicle and a situation where the driver views an indicator or the like in the vehicle, depending on the position of the object relative to the driver. It is therefore an object of the present application to perform appropriate operation assistance according to what a driver of a movable body views.

In order to solve the above-described problem, an object of the present application is to perform appropriate operation assistance according to what a driver of a movable body views. Such operation assistance will result in further improvement in traffic safety, which contributes to development in sustainable transportation system.

### SUMMARY OF THE INVENTION

An operation assistance system according to a first aspect for achieving the above-described object includes: a surrounding object recognition section that recognizes an object existing around a movable body; a driver image acquisition section that acquires an image of a driver in the movable body; a line-of-sight direction recognition section that recognizes a direction of a line of sight of the driver on a basis of the image; a length-between-pupils recognition section that recognizes a length between right and left pupils of the driver on a basis of the image; a viewing-object determination section that determines whether or not the driver views the object on a basis of the direction of the line of sight of the driver and the length between pupils of the driver; and a drive assistance control section that executes drive assistance processing for assisting driving of the movable body in a case where the viewing-object determination section determines that the driver does not view the object.

In the operation assistance system according to the first aspect, the drive assistance control section may execute alert processing of activating a notification device mounted on the movable body as the drive assistance processing.

In the operation assistance system according to the first aspect, the drive assistance control section may execute contact avoidance processing of activating a braking device or a steering device mounted on the movable body in order to avoid contact between the movable body and the object as the drive assistance processing.

An operation assistance system according to a second aspect for achieving the above-described object includes: a user image acquisition section that images a user in a movable body and acquires an image of the user; a line-of-sight direction recognition section that recognizes a direction of a line of sight of the user on a basis of the image; a length-between-pupils recognition section that recognizes a length between right and left pupils of the user on a basis of the image; a viewing-operation-portion determination section that determines whether or not the user views an operation portion in a predetermined position of the movable body on a basis of the direction of the line of sight of the user and the length between pupils of the user; and an operation reception section that executes predetermined processing corresponding to the operation portion in a case where the viewing-operation-portion determination section determines that the user views the operation portion.

In the operation assistance system according to the second aspect, the operation portion may be an operation icon projected on a window glass of the movable body by a display device mounted on the movable body.

An operation assistance method to be executed by a computer according to a third aspect for achieving the above-described object includes: a surrounding object recognition step of recognizing an object existing around a movable body; a driver image acquisition step of acquiring an image of a driver in the movable body; a line-of-sight direction recognition step of recognizing a direction of a line of sight of the driver on a basis of the image; a length-between-pupils recognition step of recognizing a length between right and left pupils of the driver on a basis of the image; a viewing-object determination step of determining whether or not the driver views the object on a basis of the direction of the line of sight of the driver and the length between pupils of the driver; and a drive assistance control step of executing drive assistance processing for assisting driving of the movable body in a case where it is determined that the driver does not view the object in the viewing-object determination step.

An operation assistance method to be executed by a computer according to a fourth aspect for achieving the above-described object includes: a user image acquisition step of acquiring an image of a user in a movable body by imaging the user; a line-of-sight direction recognition step of recognizing a direction of a line of sight of the user on a basis of the image; a length-between-pupils recognition step of recognizing a length between right and left pupils of the user on a basis of the image; a viewing-operation-portion determination step of determining whether or not the user views an operation portion in a predetermined position of the movable body on a basis of the direction of the line of sight of the user and the length between pupils of the user; and an operation reception step of executing predetermined processing corresponding to the operation portion in a case where it is determined that the user views the operation portion in the viewing-operation-portion determination step.

According to the above-described operation assistance system and operation assistance method, an object viewed by a driver of a movable body can be appropriately recognized, and an operation by the driver can be assisted.

### BRIEF DESCRIPTION OF THE DRAWINGS

FIG. 1 is a configuration diagram of an operation assistance system;

FIG. 2 is a configuration diagram of a vehicle in the vicinity of a driver seat;

FIG. 3 is an explanatory diagram illustrating the length between pupils of a driver viewing a distant place;

FIG. 4 is an explanatory diagram illustrating the length between pupils of the driver viewing an image displayed by a HUD;

FIG. 5 is an explanatory diagram of an alerting display;

FIG. 6 is a first flowchart of operation assistance processing; and

FIG. 7 is a second flowchart of operation assistance processing.

### DETAILED DESCRIPTION OF THE PREFERRED EMBODIMENTS

### 1. Configuration of Display Control Device

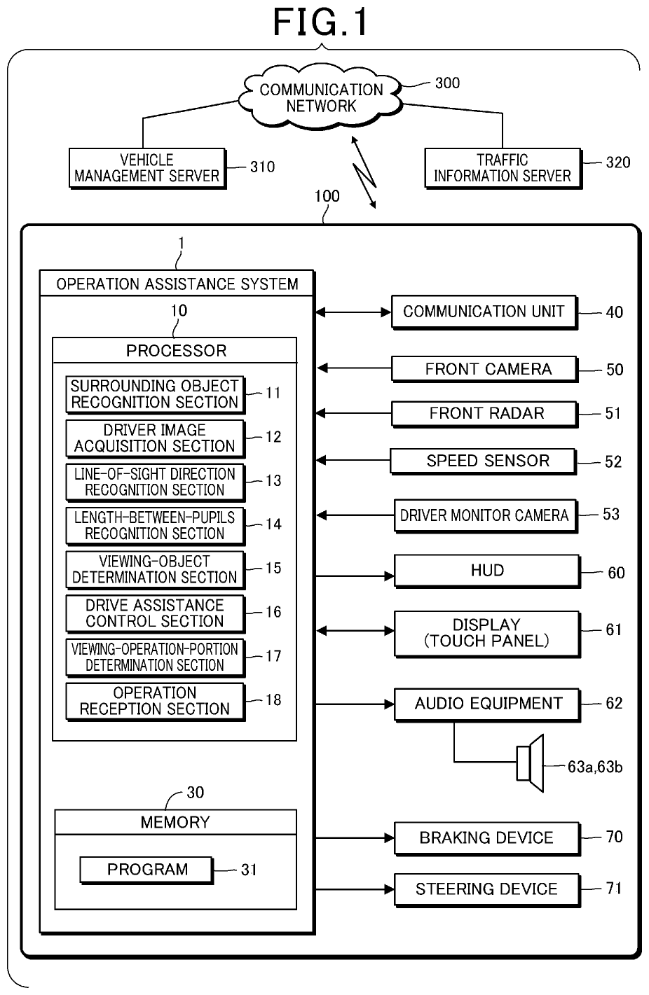

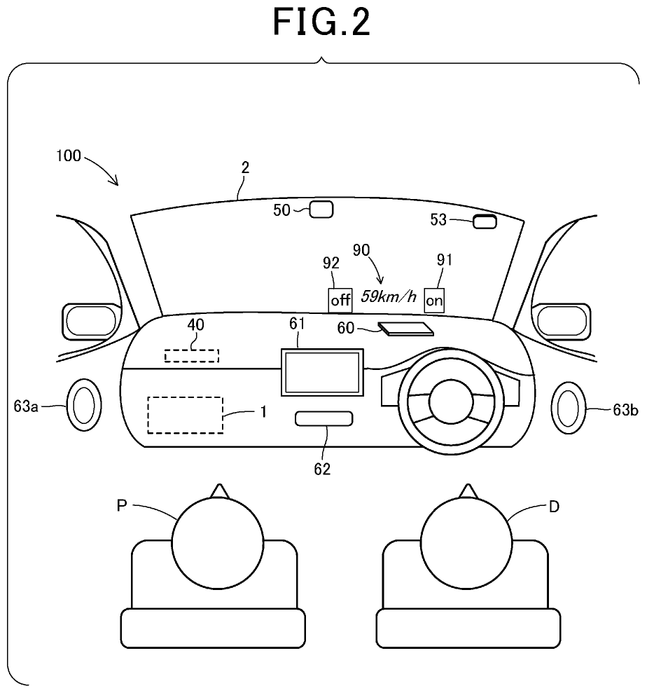

The configuration of an operation assistance system 1 according to the present disclosure will be described with reference to FIGS. 1 and 2. With reference to FIG. 1, the operation assistance system 1 is mounted on a vehicle 100, and connected to a communication unit 40, a front camera 50, a front radar 51, a speed sensor 52, a driver monitor camera 53, a head-up display (HUD) 60, a display 61, audio equipment 62, a braking device 70, and a steering device 71, which are mounted on the vehicle 100. The audio equipment 62 is connected to speakers 63a and 63b.

The vehicle 100 corresponds to the movable body according to the present disclosure. A touch panel having a touch sensor disposed on the surface of a flat panel display serves as the display 61. The HUD 60 and the audio equipment 62 correspond to the notification device according to the present disclosure.

The communication unit 40 communicates with external communication systems such as a vehicle management server 310 and a traffic information server 320 via communication network 300. The front camera 50 images a front direction of the vehicle 100 and inputs a front-direction image to the operation assistance system 1. The front radar 51 detects the position of an object in front of the vehicle 100 and inputs position detection data to the operation assistance system 1. The speed sensor 52 detects the travelling speed of the vehicle 100 and inputs speed detection data to the operation assistance system 1.

With reference to FIG. 2, the driver monitor camera 53 is disposed on, for example, an upper portion of a front window (front window glass) 2 of the vehicle 100, and images a driver D of the vehicle 100 and inputs an image of the driver D to the operation assistance system 1. The driver D also corresponds to the user of the present disclosure. The HUD 60 projects information image 90 indicating the travelling speed and the like of the vehicle 100, an on button 91 for instructing the audio equipment 62 to start sound output, and an off button 92 for instructing the audio equipment 62 to stop sound output, on the front window 2. The information image 90, the on button 91, and the off button 92 are superimposed on objects to be viewed by the driver D in front of the vehicle 100 (road, preceding vehicle, oncoming vehicle, scenery, and the like). The on button 91 and the off button 92 correspond to the operation icon of the present disclosure.

Although FIG. 2 illustrates the example in which the HUD 60 projects the information image 90 indicating the travelling speed, the on button 91, and the off button 92, the information image 90 may also include traffic information provided from the traffic information server 320, route guidance information input from a navigation device mounted on the vehicle 100, and the like. Furthermore, the HUD 60 also projects alerting display relating to objects around the vehicle 100, as described later.

With reference to FIG. 1, the operation assistance system 1 is a control unit including a processor 10, a memory 30, and the like. The processor 10 may be a single-processor or a multi-processor. The memory 30 stores a program 31 for controlling the operation assistance system 1. The program 31 may be read from a recording medium (such as magnetic disk, optical disc, flash memory, and the like) and stored in the memory 30, or may be downloaded from the vehicle management server 310 or the like and stored in the memory 30.

The processor 10 reads and executes the program 31, thereby functioning as a surrounding object recognition section 11, a driver image acquisition section 12, a line-of-sight direction recognition section 13, a length-between-pupils recognition section 14, a viewing-object determination section 15, a drive assistance control section 16, a viewing-operation-portion determination section 17, and an operation reception section 18.

The processing executed by the surrounding object recognition section 11 corresponds to the surrounding object recognition step in the operation assistance method of the present disclosure, and the processing executed by the driver image acquisition section 12 corresponds to the driver image acquisition step in the operation assistance method of the present disclosure. The processing executed by the line-of-sight direction recognition section 13 corresponds to the line-of-sight direction recognition step in the operation assistance method of the present disclosure, and the processing executed by the length-between-pupils recognition section 14 corresponds to the length-between-pupils recognition step in the operation assistance method of the present disclosure.

The processing executed by the viewing-object determination section 15 corresponds to the viewing-object determination step in the operation assistance method of the present disclosure, and the processing executed by the drive assistance control section 16 corresponds to the drive assistance control step in the operation assistance method of the present disclosure. The processing executed by the viewing-operation-portion determination section 17 corresponds to the viewing-operation-portion determination step of the present disclosure, and the processing executed by the operation reception section 18 corresponds to the operation reception step of the present disclosure.

The surrounding object recognition section 11 searches for an object existing in front of the vehicle 100 on the basis of a front-direction image of the vehicle 100 captured by the front camera 50 and position detection data relating to the object in front of the vehicle 100 detected by the front radar 51. When extracting the object, the surrounding object recognition section 11 obtains time to collision (TTC), which is an estimated time before the vehicle 100 collides with the object, and recognizes the object the TTC for which is less than a predetermined time as a target for drive assistance.

The driver image acquisition section 12 acquires an image of the driver D captured by the driver monitor camera 53. The line-of-sight direction recognition section 13 extracts an image portion of pupils of the driver D from the image of the driver D acquired by the driver image acquisition section 12, and recognizes the direction of the line of sight of the driver D. The length-between-pupils recognition section 14 extracts an image portion of right and left pupils of the driver D from the image of the driver D acquired by the driver image acquisition section 12, and recognizes the length between the pupils of the driver D.

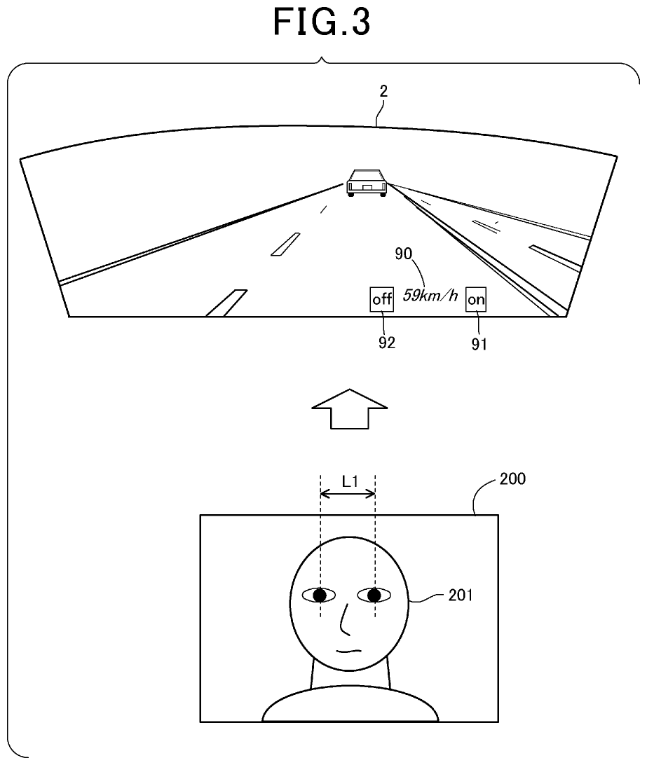

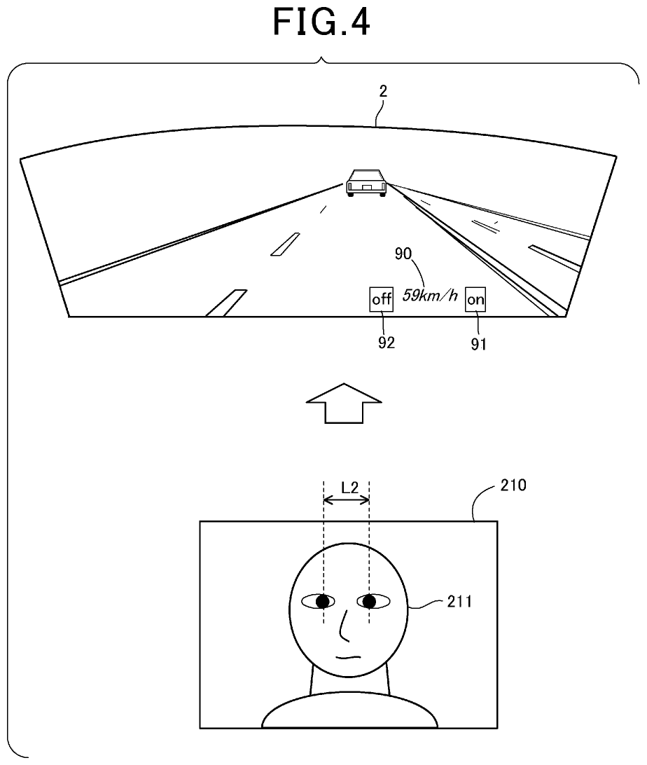

FIG. 3 illustrates an image portion 201 of the driver D in an image 200 captured by the driver monitor camera 53 in the state where the driver D views a distant vehicle and the like through the front window 2. In this state, the length between the pupils of the driver D is L1. In contrast, FIG. 4 illustrates an image portion 211 of the driver D in an image 210 captured by the driver monitor camera 53 in the state where the driver D views the information image 90, the on button 91, or the off button 92 projected on the front window 2 by the HUD 60. In this state, the length between the pupils of the driver D is L2 (<L1).

As illustrated in FIGS. 3 and 4, the length between the pupils of the driver D is longer when the driver D views a distant place (the state of FIG. 3) than when the driver D views a near place (the state of FIG. 4). Hence, the object viewed by the driver D can be recognized as an outside object distant from the vehicle 100 or an image projected on the front window 2 by the HUD 60, through recognition of the length between the pupils of the driver D. For example, it can be determined that the driver D views an object outside the vehicle 100 in the case where the length between the pupils is more than or equal to a predetermined threshold, whereas it can be determined that the driver D views an image projected on the front window 2 by the HUD 60 in the case where the length between the pupils is less than the predetermined threshold.

In the case where the surrounding object recognition section 11 recognizes an object that is a target for drive assistance, the viewing-object determination section 15 determines whether or not the driver D views the object on the basis of the direction of the line of sight of the driver D recognized by the line-of-sight direction recognition section 13 and the length between the pupils of the driver D recognized by the length-between-pupils recognition section 14.

In the case where the viewing-object determination section 15 determines that the driver D does not view the object, the drive assistance control section 16 executes the following alert processing and contact avoidance processing as drive assistance processing.

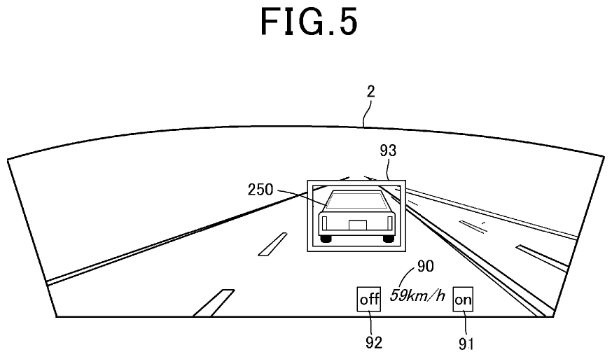

Alert processing: The drive assistance control section 16 causes the HUD 60 to project an outer frame 93 in the direction from the driver D to an object 250 (in this case, preceding vehicle) as notification display, as illustrated in FIG. 5. Furthermore, the drive assistance control section 16 causes the audio equipment 62 to output notification sound for calling attention (“pay attention to the preceding vehicle”, and the like) from the speakers 63a and 63b. Note that either the notification display or the notification sound output may be performed.

Contact avoidance processing: The drive assistance control section 16 activates the braking device 70 and causes the vehicle 100 to reduce the speed. Furthermore, the drive assistance control section 16 activates the steering device 71 to cause the vehicle 100 to travel in a direction not intersecting with the object. Note that either the braking device 70 or the steering device 71 may be activated.

The viewing-operation-portion determination section 17 determines whether or not the driver D views the on button 91 or the off button 92 on the basis of the direction of the line of sight of the driver D recognized by the line-of-sight direction recognition section 13 and the length between the pupils of the driver D recognized by the length-between-pupils recognition section 14. In the case where the viewing-operation-portion determination section 17 determines that the driver D views the on button 91, the operation reception section 18 causes the audio equipment 62 to start sound output. In the case where the viewing-operation-portion determination section 17 determines that the driver D views the off button 92, the operation reception section 18 causes the audio equipment 62 to stop sound output.

In this manner, the driver D can stop the sound output from the speakers 63a and 63b through a simple operation of viewing the off button 92, which can minimally affect the driving operation, when, for example, the driver D feels that the sound which the audio equipment 62 causes the speakers 63a and 63b to output is annoying during conversation with a passenger P. In addition, the driver D can resume the sound output from the speakers 63a and 63b through a simple operation of viewing the on button 91, which can minimally affect the driving operation, after the conversation with the passenger P is finished.

### 2. Operation Assistance Processing

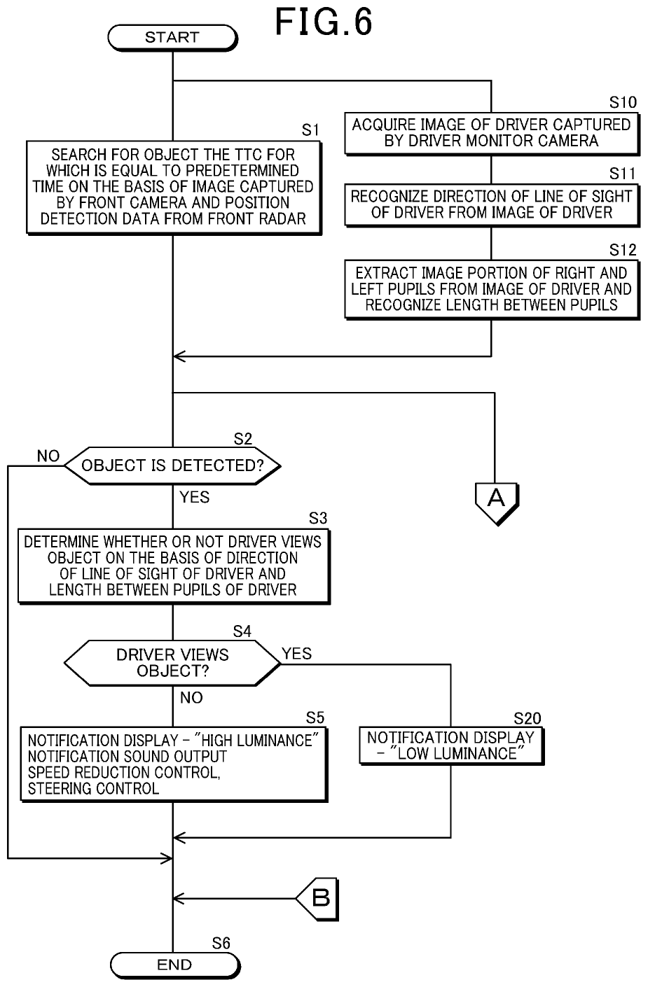

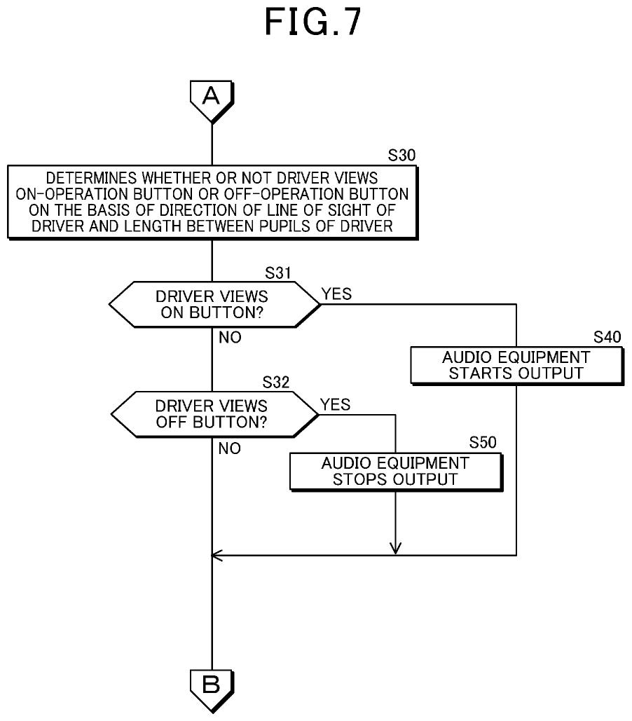

The procedure of the operation assistance processing executed by the operation assistance system 1 will be described according to the flowcharts shown in FIGS. 6 and 7. The operation assistance system 1 repeatedly executes the processing shown in the flowcharts shown in FIGS. 6 and 7 while the vehicle 100 is in an activated state (power-on state).

The processing of step S1 and the processing of steps S10 to S12 of FIG. 6 are parallelly executed. In step S1, the surrounding object recognition section 11 searches for an object the TTC for which is equal to a predetermined time on the basis of the image captured by the front camera 50 and the position detection data from the front radar 51. In step S10, the driver image acquisition section 12 acquires an image of the driver D captured by the driver monitor camera 53. In subsequent step S11, the line-of-sight direction recognition section 13 recognizes the direction of the line of sight of the driver D from the image of the driver D, and in step S12, the length-between-pupils recognition section 14 recognizes the length between pupils of the driver D from the image of the driver D.

The processing of subsequent steps S2 to S5 and step S20 of FIG. 6 and the processing of steps S30 to S32, step S40, and step S50 of FIG. 7 are parallelly executed. In step S2, the surrounding object recognition section 11 proceeds to the processing of step S3 when the object is detected, and proceeds to the processing of step S6 when the object is not detected. In step S3, the viewing-object determination section 15 determines whether the driver D views the object on the basis of the direction of the line of sight of the driver D and the length between pupils of the driver D.

In subsequent step S4, the drive assistance control section 16 proceeds to the processing of step S20 when the viewing-object determination section 15 determines that the driver D views the object, or proceeds to the processing of step S5 when the viewing-object determination section 15 determines that the driver D does not view the object.

In step S20, the drive assistance control section 16 causes the HUD 60 to display the outer frame 93 shown in FIG. 5 at low luminance, and proceeds to the processing of step S6. In step S5, the drive assistance control section 16 causes the HUD 60 to display the outer frame 93 shown in FIG. 5 at high luminance as the notification display, and causes the audio equipment 62 to output the notification sound from the speakers 63a and 63b. Furthermore, the drive assistance control section 16 causes the braking device 70 and the steering device 71 to activate.

In step S30 of FIG. 7, the viewing-operation-portion determination section 17 determines whether or not the driver D views the on button 91 or the off button 92 on the basis of the direction of the line of sight of the driver D and the length between pupils of the driver D. In subsequent step S31, the operation reception section 18 proceeds to the processing of step S40 when the viewing-operation-portion determination section 17 determines that the driver D views the on button 91, or proceeds to the processing of step S32 when the viewing-operation-portion determination section 17 determines that the driver D does not view the on button 91. In step S40, the operation reception section 18 causes the audio equipment 62 to start sound output from the speakers 63a and 63b.

In step S32, the operation reception section 18 proceeds to the processing of step S50 when the viewing-operation-portion determination section 17 determines that the driver D views the off button 92, or proceeds to the processing of step S6 of FIG. 6 when the viewing-operation-portion determination section 17 determines that the driver D does not view the off button 92. In step S50, the operation reception section 18 causes the audio equipment 62 to stop sound output from the speakers 63a and 63b.

### 3. Other Embodiments

Although the above embodiment shows the vehicle 100 as the movable body according to the present disclosure, the movable body according to the present disclosure only needs to be a movable body that is operated and driven by a driver, and may be an aircraft, a ship, or the like.

Although the above embodiment shows a configuration where the operation assistance system 1 according to the present disclosure is mounted on the vehicle 100, the configuration of the operation assistance system 1 may be partially or entirely provided in an external system outside of the vehicle 100 such as the vehicle management server 310. In this case, the operation assistance for the vehicle 100 is achieved by a configuration where the information obtained in the vehicle 100 is transmitted to the external system, the external system then executes processing for the operation assistance, and control data based on the result of the processing is transmitted to the vehicle 100.

According to the above embodiment, the viewing-operation-portion determination section 17 and the operation reception section 18, which are targeted to the driver D, receive the operations to the on button 91 and the off button 92. As another embodiment, such sections may be targeted to the passenger P to receive the operations to the on button 91 and the off button 92 by recognizing the direction of the line of sight of the passenger P and the length between pupils of the passenger P. Furthermore, the button for receiving operations based on viewing may be used for other than start and stop of sound output by the audio equipment 62, and may be a button displayed on the display 61 or a physical button provided to the vehicle 100 other than the button projected by the HUD 60.

According to the above embodiment, assistance in driving operation is performed by provision of the viewing-object determination section 15 and the drive assistance control section 16, and assistance in switching operation is performed by provision of the viewing-operation-portion determination section 17 and the operation reception section 18. As another embodiment, either assistance in driving operation or assistance in switching operation may be performed.

Note that FIG. 1 is a schematic diagram where the configuration of the operation assistance system 1 is divided according to principal processing content to facilitate understanding of the present invention, and the configuration of the operation assistance system 1 may be divided according to another way of classification. In addition, the processing of respective components may be executed by one hardware unit or by a plurality of hardware units. Furthermore, the processing of respective components shown in FIGS. 6 and 7 may be executed by one program or by a plurality of programs.

### 4. Configurations Supported by the Above Embodiments

The above embodiments are specific examples of the following configurations.

(Configuration 1) An operation assistance system including: a surrounding object recognition section that recognizes an object existing around a movable body; a driver image acquisition section that acquires an image of a driver in the movable body; a line-of-sight direction recognition section that recognizes a direction of a line of sight of the driver on a basis of the image; a length-between-pupils recognition section that recognizes a length between right and left pupils of the driver on a basis of the image; a viewing-object determination section that determines whether or not the driver views the object on a basis of the direction of the line of sight of the driver and the length between pupils of the driver; and a drive assistance control section that executes drive assistance processing for assisting driving of the movable body in a case where the viewing-object determination section determines that the driver does not view the object.

According to the operation assistance system of the configuration 1, the drive assistance processing for assisting driving of the movable body can be executed as appropriate operation assistance suitable for the situation where the driver does not view the object around the movable body, on the basis of the direction of the line of sight and the length between pupils of the driver of the movable body.

(Configuration 2) The operation assistance system according to the configuration 1, in which the drive assistance control section executes alert processing of activating a notification device mounted on the movable body as the drive assistance processing.

According to the operation assistance system of the configuration 2, the execution of the alert processing can urge the driver to perform an operation in order to avoid contact with the object.

(Configuration 3) The operation assistance system according the configuration 1 or 2, in which the drive assistance control section executes contact avoidance processing of activating a braking device or a steering device mounted on the movable body in order to avoid contact between the movable body and the object as the drive assistance processing.

According to the operation assistance system of the configuration 3, the execution of the contact avoidance processing can support an operation by the driver for avoiding contact with the object.

(Configuration 4) An operation assistance system including: a user image acquisition section that images a user in a movable body and acquires an image of the user; a line-of-sight direction recognition section that recognizes a direction of a line of sight of the user on a basis of the image; a length-between-pupils recognition section that recognizes a length between right and left pupils of the user on a basis of the image; a viewing-operation-portion determination section that determines whether or not the user views an operation portion in a predetermined position of the movable body on a basis of the direction of the line of sight of the user and the length between pupils of the user; and an operation reception section that executes predetermined processing corresponding to the operation portion in a case where the viewing-operation-portion determination section determines that the user views the operation portion.

According to the operation assistance system of the configuration 4, predetermined processing corresponding to the operation portion is executed as appropriate operation assistance suitable for the situation where it is determined that the user views the operation portion on the basis of the direction of the line of sight and the length between pupils of the user of the movable body, so that the operation portion can be operated based on viewing.

(Configuration 5) The operation assistance system according to the configuration 4, in which the operation portion comprises an operation icon projected on a window glass of the movable body by a display device mounted on the movable body.

According to the operation assistance system of the configuration 5, it can be determined that the user views an operation icon from the length between pupils of the user, which changes according to the distance between the user and an object to be viewed, even when it is difficult to determine whether a user views an operation icon or an object around the movable body through a window glass only on the basis of the direction or line of sight of the user for the reason that an operation icon projected on a window glass of the movable body serves as the operation portion.

(Configuration 6) An operation assistance method to be executed by a computer, the method including: a surrounding object recognition step of recognizing an object existing around a movable body; a driver image acquisition step of acquiring an image of a driver in the movable body; a line-of-sight direction recognition step of recognizing a direction of a line of sight of the driver on a basis of the image; a length-between-pupils recognition step of recognizing a length between right and left pupils of the driver on a basis of the image; a viewing-object determination step of determining whether or not the driver views the object on a basis of the direction of the line of sight of the driver and the length between pupils of the driver; and a drive assistance control step of executing drive assistance processing for assisting driving of the movable body in a case where it is determined that the driver does not view the object in the viewing-object determination step.

The same function and effect as those of the operation assistance system of the configuration 1 can be achieved through execution of the operation assistance method of the configuration 6 by a computer.

(Configuration 7) An operation assistance method to be executed by a computer, the method including: a user image acquisition step of acquiring an image of a user in a movable body by imaging the user; a line-of-sight direction recognition step of recognizing a direction of a line of sight of the user on a basis of the image; a length-between-pupils recognition step of recognizing a length between right and left pupils of the user on a basis of the image; a viewing-operation-portion determination step of determining whether or not the user views an operation portion in a predetermined position of the movable body on a basis of the direction of the line of sight of the user and the length between pupils of the user; and an operation reception step of executing predetermined processing corresponding to the operation portion in a case where it is determined that the user views the operation portion in the viewing-operation-portion determination step.

The same function and effect as those of the operation assistance system of the configuration 4 can be achieved through execution of the operation assistance method of the configuration 7 by a computer.

### REFERENCE SIGNS LIST

1: Operation assistance system, 10: Processor, 11: Surrounding object recognition section, 12: Driver image acquisition section, 13: Line-of-sight direction recognition section, 14: Length-between-pupils recognition section, 15: Viewing-object determination section, 16: Drive assistance control section, 17: Viewing-operation-portion determination section, 18: Operation reception section, 30: Memory, 31: Program, 40: Communication unit, 50: Front camera, 51: Front radar, 52: Speed sensor, 53: Driver monitor camera, 60: HUD, 61: Display, 62: Audio equipment, 63a, 63b: Speaker, 70: Braking device, 71: Steering device, 90: Information image, 91: On button, 92: Off button, 100: Vehicle, 200, 210: Image captured by driver monitor camera, 201, 211: Image portion of driver, D: Driver, P: Passenger

What is claimed is:

1. An operation assistance system comprising:
a surrounding object recognition section that recognizes an object existing around a movable body;
a driver image acquisition section that acquires an image of a driver in the movable body;
a line-of-sight direction recognition section that recognizes a direction of a line of sight of the driver on a basis of the image;
a length-between-pupils recognition section that recognizes a length between right and left pupils of the driver on a basis of the image;
a viewing-object determination section that determines whether or not the driver views the object on a basis of the direction of the line of sight of the driver and the length between pupils of the driver; and
a drive assistance control section that executes drive assistance processing for assisting driving of the movable body in a case where the viewing-object determination section determines that the driver does not view the object.

2. The operation assistance system according to claim 1, wherein the drive assistance control section executes alert processing of activating a notification device mounted on the movable body as the drive assistance processing.

3. The operation assistance system according to claim 1, wherein the drive assistance control section executes contact avoidance processing of activating a braking device or a steering device mounted on the movable body in order to avoid contact between the movable body and the object as the drive assistance processing.

4. An operation assistance system comprising:
a user image acquisition section that images a user in a movable body and acquires an image of the user;
a line-of-sight direction recognition section that recognizes a direction of a line of sight of the user on a basis of the image;
a length-between-pupils recognition section that recognizes a length between right and left pupils of the user on a basis of the image;
a viewing-operation-portion determination section that determines whether or not the user views an operation portion in a predetermined position of the movable body on a basis of the direction of the line of sight of the user and the length between pupils of the user; and
an operation reception section that executes predetermined processing corresponding to the operation portion in a case where the viewing-operation-portion determination section determines that the user views the operation portion.

5. The operation assistance system according to claim 4, wherein the operation portion comprises an operation icon projected on a window glass of the movable body by a display device mounted on the movable body.

6. An operation assistance method to be executed by a computer, the method comprising:
a surrounding object recognition step of recognizing an object existing around a movable body;
a driver image acquisition step of acquiring an image of a driver in the movable body;
a line-of-sight direction recognition step of recognizing a direction of a line of sight of the driver on a basis of the image;
a length-between-pupils recognition step of recognizing a length between right and left pupils of the driver on a basis of the image;
a viewing-object determination step of determining whether or not the driver views the object on a basis of the direction of the line of sight of the driver and the length between pupils of the driver; and
a drive assistance control step of executing drive assistance processing for assisting driving of the movable body in a case where it is determined that the driver does not view the object in the viewing-object determination step.

7. An operation assistance method to be executed by a computer, the method comprising:
a user image acquisition step of acquiring an image of a user in a movable body by imaging the user;
a line-of-sight direction recognition step of recognizing a direction of a line of sight of the user on a basis of the image;
a length-between-pupils recognition step of recognizing a length between right and left pupils of the user on a basis of the image;
a viewing-operation-portion determination step of determining whether or not the user views an operation portion in a predetermined position of the movable body on a basis of the direction of the line of sight of the user and the length between pupils of the user; and
an operation reception step of executing predetermined processing corresponding to the operation portion in a case where it is determined that the user views the operation portion in the viewing-operation-portion determination step.
